(19) United States
(12) Patent Application Publication
(10) Pub. No.: US 2017/0249677 A1
(43) Pub. Date: Aug. 31, 2017

(54) Table-Side Device Integration To A Point-Of-Sale (POS) Hospitality System

(71) Applicant: Tabletop Media LLC d/b/a Ziosk, Dallas, TX (US)

(72) Inventors: Viren R. Balar, Murphy, TX (US); Vernon Y. Franklin, Prosper, TX (US); Kevin Mowry, Lewisville, TX (US); David C. Perez, Mesquite, TX (US); Scott A. Rudy, Savoy, TX (US)

(21) Appl. No.: 15/595,704

(22) Filed: May 15, 2017

Related U.S. Application Data
(63) Continuation of application No. 14/079,389, filed on Nov. 13, 2013.

(51) Int. Cl. G06Q 30/06; G06Q 30/04; G06Q 20/14; G06Q 20/20; G06Q 20/32

(52) U.S. Cl. CPC G06Q 30/0601; G06Q 20/20; G06Q 20/32; G06Q 20/145; G06Q 30/04

(57) ABSTRACT

A table-side device is seamlessly and securely integrated to an existing customer POS system within an operating environment, irrespective of the particular operating characteristics of the POS system. In one embodiment, this is achieved by providing a middleware component that executes in the POS system, preferably in the form of an agent that interfaces each table-side device to the POS system for one of: order entry and update, check management, and payment handling. The POS agent is associated with a plug-in component, which is uniquely associated with the particular POS system. The POS agent preferably includes a communication interface through which table-side devices issue requests to the POS system through the plug-in component. The agent middleware enables the single service provider system to interoperate with various types of POS systems irrespective of the underlying differences in implementation among these various third party POS systems.

### RELATED APPLICATIONS

This application is a continuation of U.S. Non-Provisional Patent Application No. 14/079,389, entitled “Table-side Device Integration to a Point-Of-Sale (POS) Hospitality System,” filed Nov. 13, 2013. The above application is incorporated herein by reference for all purposes.

### BACKGROUND

Technical Field

This disclosure relates generally to mechanisms for enhancing the capabilities of promotion/pay-at-the-table devices that are used in restaurant and hospitality environments, and to enable such devices to integrate with various types of point-of-sale (POS) systems.

Background of the Related Art

A system of digital promotion/pay-at-the-table devices is known in the prior art. One such commercial system is the Ziosk, available from Tabletop Media, LLC, of Dallas Texas.

A Ziosk® device typically is implemented as an apparatus that comprises, within a self-contained housing, a display, a reader, a printer, electronics, and a battery. The housing is configured to position the display to a patron seated at a serving area for order data entry, display of information, and invoicing. A server computer is communicatively coupled to the apparatus over a wireless link and is adapted to transmit a control program to the apparatus, and to transmit the information. A control program executing on the apparatus facilitates order entry, order management, point-of-sale system integration, and pay-at-the-table processing. During the payment workflow, an invoice is displayed, a payment (e.g., via credit card, gift card, pre-paid card or debit card) is received and processed, and the invoice is printed.

To work effectively for its intended purpose, a device of this type needs to interface to a conventional point-of-sale (POS) system within a restaurant or other hospitality environment in which the device is being used. As is known in the prior art, a traditional POS system has several terminals spread throughout the restaurant to allow wait staff to place orders, to accept payments, and to print closed checks. These terminals are connected to a central computer or server that handles the control and processing of orders. From this central controller, orders are traditionally sent to a screen (typically an in-kitchen display) or printed in the kitchen. Commercial vendors of these types of POS systems include, without limitation, Radiant Systems, Micros Systems, POSitouch Systems, and others. Some restaurants implement their own proprietary POS systems. Regardless of implementation, generally these systems are currently limited to wired connections, which can be secured much easier than communications over wireless local area networks (WLANs). Moreover, these systems are mostly self-contained, and they are not guest-facing and thus do not have promotional display elements or end user interactivity.

While these distinct POS systems have some common features and functions, not surprisingly these known POS systems come in various types, and these differences make interfacing with such systems (e.g., using a device such as the Ziosk®) quite challenging. Thus, for example, the terminals are commonly touchscreen interfaces that have a user interface that is customized for the wait staff, and these customizations often vary across system or even restaurant. At some restaurants, the terminal is connected to a cash drawer and magnetic strip card reader whereas, at other restaurants, the terminal is a standalone device that is only used as an order entry and credit card payment interface with a cash drawer located at a central terminal. Each POS system typically has its own way of ensuring that checks are opened, managed and closed. Another complication is that POS systems are traditionally designed with proprietary limitations and only work with their own terminals, software interfaces and credit card payment systems. As a result, larger chain restaurant customers and companies often have off-the-shelf POS systems customized to meet their own particular needs or requirements.

There remains a need to provide techniques to enable a third party-sourced digital promotion/pay-at-the-table device to interoperate with these myriad POS systems. This disclosure addresses this need.

### BRIEF SUMMARY

According to this disclosure, a table-side hospitality device is seamlessly and securely integrated to an existing customer POS system within a restaurant or other hospitality operating environment, irrespective of the particular operating characteristics of the POS system. In one embodiment, this is achieved by providing a middleware component that executes in the POS system, preferably in the form of a point-of-sale (POS) agent that interfaces each table-side device to the POS system for one of: order entry and update, menu item pricing, price scheduling, check management, and payment handling. The POS agent overlays a plug-in component that is uniquely associated with a particular POS system. Preferably, the plug-in exposes POS system-specific functionality. The POS agent preferably includes a communication interface layer and an application programming interface (API) through which one or more table-side devices issue requests to the POS system through the plug-in component. The agent middleware enables the single service provider system to interoperate with various types of POS systems (commercial or proprietary) irrespective of the underlying differences in implementation among these various third party POS systems. In this manner, the single service provider system is adapted for easy, yet reliable and secure integration with multiple different types of restaurant POS systems.

The foregoing has outlined some of the more pertinent features of the subject matter. These features should be construed to be merely illustrative.

### BRIEF DESCRIPTION OF THE DRAWINGS

For a more complete understanding of the disclosed subject matter and the advantages thereof, reference is now made to the following descriptions taken in conjunction with the accompanying drawings, in which:

FIG. 1 is a representation of a known table-side device and its control hardware and software;

FIG. 2 is a block diagram of a service provider's table-side system integrated with a host point-of-sale (POS) system according to this disclosure;

FIG. 3 is a block diagram of a POS agent according to the disclosure;

FIG. 4 illustrates representative interactions and content and data delivery among at table-side device, a local device controller, and a POS system in a first embodiment;

FIG. 5 illustrates representative interactions and content and data delivery among the components in a second embodiment; and

FIGS. 6A-6B illustrates a UML diagram illustrating a preferred technique for authenticating the table-side unit to the POS agent according to this disclosure.

### DETAILED DESCRIPTION OF AN ILLUSTRATIVE EMBODIMENT

As noted above, a system of digital promotion/pay-at-the-table devices is known in the prior art. One such commercial system is the Ziosk, available from Tabletop Media, LLC, of Dallas Texas. As noted above, a Ziosk® device typically is implemented as a standalone apparatus that comprises, within a self-contained housing, a display, a reader, a printer, electronics, and a battery. The housing is configured to position the display to a patron seated at a serving area for order data entry, display of information, and invoicing. A server computer (not shown) is communicatively coupled to the apparatus, typically over a wireless link, and it is adapted to transmit a control program to the apparatus, and to transmit the information. A control program executing on the apparatus facilitates the invoicing by selectively displaying an invoice on the display, receiving a payment, and providing an indication that a payment has been accepted.

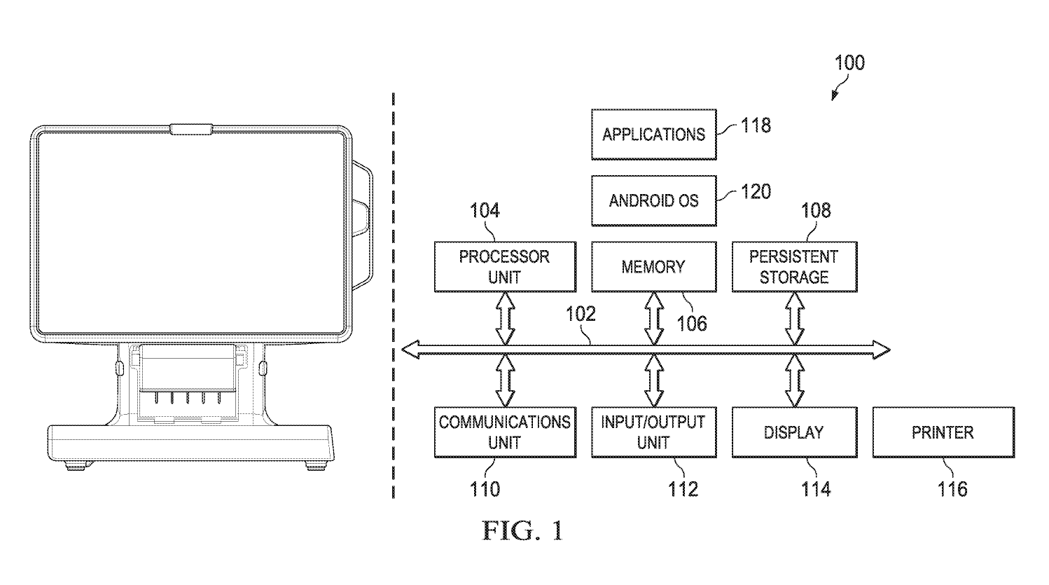

FIG. 1 illustrates a representative architecture for the device 100, which includes a communications bus 102, which provides communications among a processor 104, memory 106, persistent storage 108, communications unit 110, input/output (I/O) unit 112, display 114, and printer 116. The processor 104 executes instructions for software that may be loaded into memory 106 (e.g., from persistent storage 108). The memory 106 and persistent storage 108 are storage devices. The communications unit 110 provides for communications with other data processing systems or devices. In these examples, communications unit 110 is a network interface card, or it may provide communications through the use of either or both physical and wireless communications links. The input/output unit 112 allows for input and output of data with other devices that may be connected to data processing system 100. For example, input/output unit 212 may provide a connection for user input through touch screen, through voice activation, or some other man-machine interface (MMI). Further, input/output unit 112 may send output to the printer 116. Display 114 provides a mechanism to display information to a user. Instructions for the operating system 116 (e.g., Android) and applications or programs 118 are located on persistent storage 108. These instructions are selectively loaded into memory 106 for execution by processor 104.

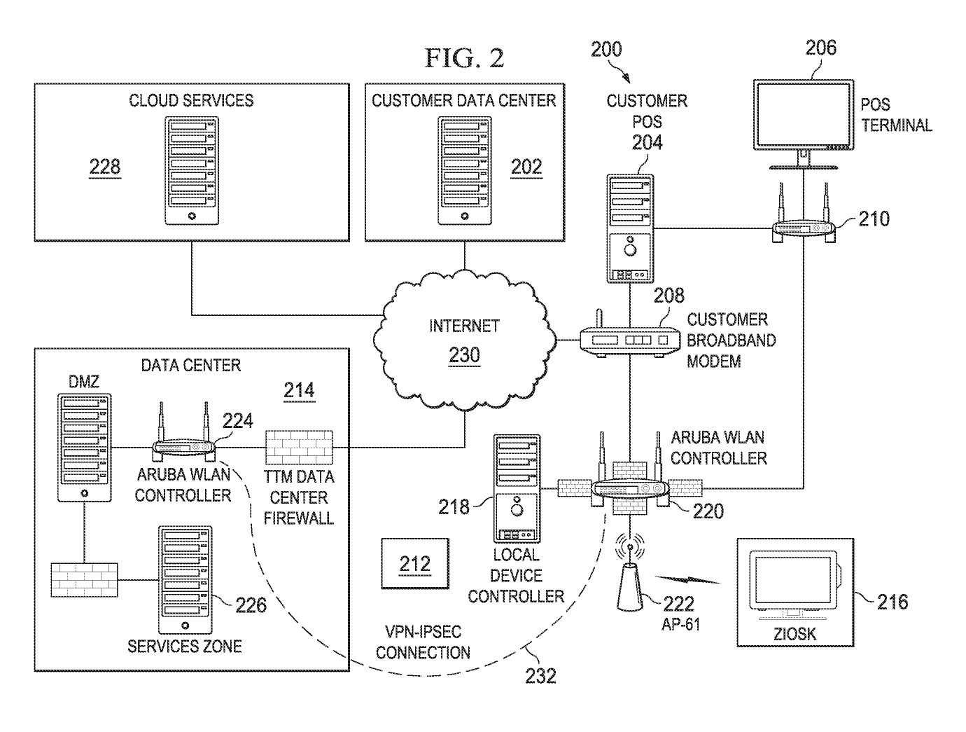

FIG. 2 shows a representative network for an overall system that, in a typical operating scenario, includes a set of the table-side devices 100 located in a facility (or even across multiple such facilities. A service provider (referred to as “TTM” for convenience) provides various networking, hardware and software resources and services to support the devices within the restaurant (the “customer”). In general, the overall system is broken into several portions, namely, the customer's equipment, the service provider's equipment, and other third party services. More specifically, the customer's equipment 200 typically includes a customer data center 202 (which may be located off-premises), a customer point-of-sale (POS) system 204, one or more POS terminals 206, and various networking and switching resources such as DSL modem 208 and switch 210. The customer's infrastructure also may include a name service, HTTP and FTP servers, administrative servers, data collection services, management and reporting servers, other backend servers, load balancing appliances, other switches, and the like (not shown). Each machine typically comprises sufficient disk and memory, as well as input and output devices. On the other hand, the service provider's equipment 212 typically comprises a service provider data center 214 located remotely, and various on-site equipment, namely, the table-side devices 216, a local device controller 218, and various wireless networking resources such as WLAN controller 220 and base stations 222 (e.g., an Aruba AP-61, with 802.11 b/g protocol support). The local device controller operates a proxy server as part of an overall content management sub-system that keeps the table unit software and content updated. The content management sub-system periodically polls the external service provider infrastructure (e.g., a content management system therein) for updates. Once an update has been located, it is retrieved to the local device controller where it is stored until the table units are ready (e.g., charged or otherwise available, or if it is otherwise time for the scheduled content to be loaded therein). As the units are charged, the update is downloaded or installed. These updates can range from new menu items to firmware/device operating software upgrades.

As illustrated, the table-side devices 216 communicate wirelessly to the WLAN controller 220 (a wireless router, such as an Aruba 800-4 mobility controller) through the base stations, using known protocols such as 802.11. The service provider data center 214 typically supports various servers, such as a content management server 224, and an administration server 226. The data center 214 may also include a name service, HTTP and FTP servers, administrative servers, data collection services, management and reporting servers, other backend servers, load balancing appliances, other switches and modems, and the like. The service provider systems also may interoperate with applications supported in a third party hosted environment 228, such as Amazon® S3 or the like. As is well-known, cloud computing using an environment 228 is a model of service delivery for enabling on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. Communications among the various systems are facilitated using IP-based networks, such as the public-routable Internet 230, private VPN-IPSEC connections 232, other known or later-developed wireless and/or wireline protocols, and the like.

Generalizing, various components shown in FIG. 2 may be co-located hardware and software resources, or resources that are physically, logically, virtually and/or geographically distinct. Communication networks used to communicate to and from the platform services may be packet-based, non-packet based, and secure or non-secure, or some combination thereof.

More generally, the techniques described herein are provided using a set of one or more computing-related entities (systems, machines, processes, programs, libraries, functions, or the like) that together facilitate or provide the described functionality described above. In a typical implementation, a representative machine on which the software executes comprises commodity hardware, an operating system, an application runtime environment, and a set of applications or processes and associated data, that provide the functionality of a given system or subsystem. As described, the functionality may be implemented in a standalone machine, or across a distributed set of machines.

Referring back to FIG. 2, as described, the equipment used by the customer is the customer POS system 204 and associated network connection (e.g., 208, 210). The customer's network connection is then connected to the wireless router 220, which is a central hub of the service provider local (in-restaurant) system. The router 220 communicates with the local device controller 218, the service provider data center 214 and other devices and systems, such as shown. The local device controller 218 typically is a machine on which various application programs execute, as will be described. One of the programs provides local content management and control for the various table-side units. The wireless router 220 (and its associated access point 222) is the link to the table-side units 216 throughout the restaurant or other hospitality area being serviced. The local device controller 218 preferably stores the content and data that is synchronization with the units 216. The communication link between a unit 216 and its associated local device controller 218 enable each in-restaurant unit to remain up-to-date, and to provide the data center 214 components with the usage and health of the individual units. The customer POS server 204 may also communicate with the content controller routines operative in the local device controller 218.

Point-of-Sale Interoperability Using a Point-of-Sale (POS) Agent

With the above as background, the techniques of this disclosure are now described.

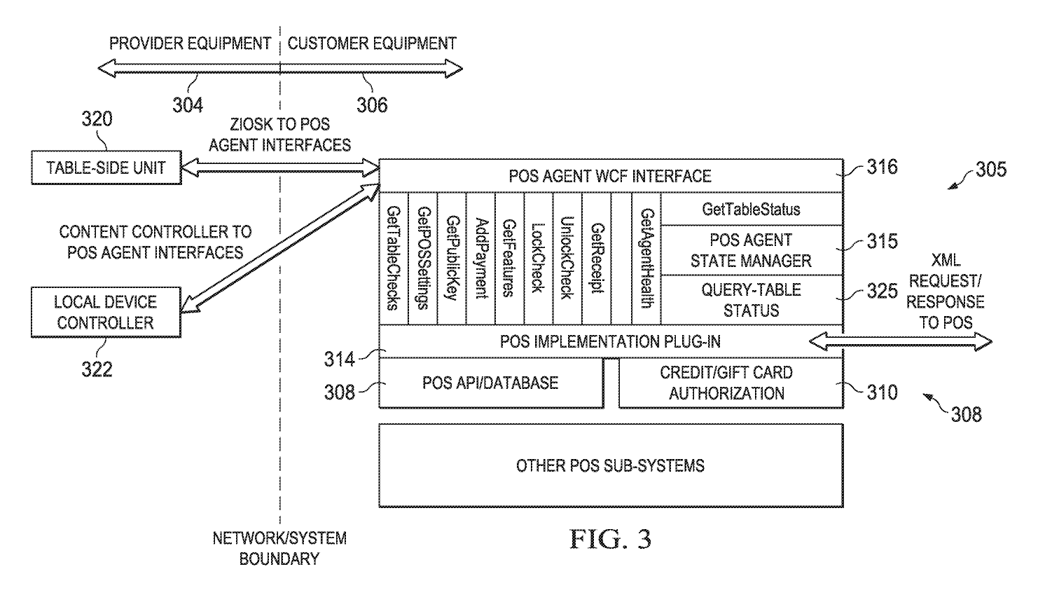

In operation, the unit 216 communicates directly with the POS server 204, for example, to request check data, order new items, re-order items, and to send payment data, and the POS server 204 provides the requesting unit 216 with various information, such as check data and payment authorization. According to this disclosure, the unit's communication with the POS server is controlled on the POS side by a service provider point-of-sale (POS) agent 305 that executes in the POS system. FIG. 3 illustrates the basic agent architecture. As illustrated, typically there is a network/system boundary 302 between the equipment 304 supplied by the service provider, and the equipment 306 supplied by the customer. Generally, the POS agent 305 is a middleware component that serves as the service provider's system interface into the customer's POS system. As will be described, the POS agent 305 implements an abstraction layer for various (typically distinct) POS systems to thereby provide the other service provider components in effect a homogeneous “view” of the POS system. In other words, the agent middleware enables the single service provider system to interoperate with various types of POS systems (commercial or proprietary) irrespective of the underlying differences in implementation among these various third party POS systems. In this manner, the single service provider system is adapted for easy, yet reliable and secure integration with multiple different types of restaurant POS systems.

As illustrated in FIG. 3, the host POS system 308 includes various components including one or more application programming interfaces (APIs). A first API 310 interfaces to the POS database, and a second API 312 interfaces to various credit/debit/gift card authorization sub-systems. Other POS systems and sub-systems facilitate kitchen or bar interactions, ordering, and the like, and there may be other specific or dedicated APIs to facilitate these interactions.

As also illustrated, the service provider POS agent 305 is positioned above a POS agent plug-in interface (POSPlugin) 314, and it includes a POS agent WCF interface layer (IAgent) 316 at its top. WCF refers to the Microsoft® Windows Communication Foundation, which is a known Windows-based communication interface. WCF simplifies the process of web services development by supplying a declarative approach to defining service operations and the data associated with them. In this embodiment, the POSPlugin 314 is a Microsoft .NET class library (using .NET Framework 3.5 or higher). Preferably, the plug-in 314 is discovered and loaded dynamically at runtime by the POS agent 305.

Although WCF is a desirable communications interface, other interfaces (including, without limitation, REST-based interfaces) may be used. Preferably, the communications interface used implements an intelligent queuing mechanism to buffer incoming asynchronous requests that are received from the plurality of table-side devices. As noted above, in a typical operating scenario, the table-side devices asynchronously issue requests to the POS agent (in part because the activities at each such device typically are uncoordinated).

As illustrated, preferably the individual table-side units 320 and the local device controller 322 communicate with the POS agent through the WCF interface layer 316. The IAgent interface layer 316 describes a “data contract” between the POS agent 305, the agent plug-ins, and other service provider system components, such as the table-side units 320. In particular, preferably there are classes and data types specified to facilitate the definition of information that the customer POS must supply in order for the information to be transmitted back to the table-side units. Representative contract objects may include, without limitation, a Response (a base object defining the response from a POS agent), a RequestBase (a base object defining requests from agent clients), TableStatus (a collection of table objects detailing the tables that contain open checks in the POS system), Checks (a collection of Check objects), Check (an object that includes a list of Check.Items), Check.Item (the items on a check), Adjustment (an object that maintains discounts and comps that may be applied to a check), Check.Tenders (an object that maintains the tenders/payments associated with a check), Order (an object that contains a list of items to be ordered along with relevant identifying information), Order.Item (an object defining an item to be included in the order), Payment (an object that includes payment-related information), PaymentlD (an object that is returned by the POS agent when payment is applied), PaymentResponse (an object that includes additional information such as gift card balance), Receipt (an object that includes receipt information), SplitCheck (an object that contains the response to a split total request from the table-side device), and the like. In contrast, the plug-in interface 314 describes the data types, method signatures, and properties required to implement a POS plug-in. Classes implementing a plug-in assembly for integration with a specific POS system must then provide implementations for these defined methods. Although similar to the IAgent interface (which describes the contract between the POS agent 305 and the table-side unit 320), the POSPlugin interface 314 describes the contract between an agent plug-in and the host POS system. Representative methods for this interface include, without limitation, Name (a read-only property defining the name of the plug-in), Initialize (a method called by the plug-in host when the plug-in is loaded); GetOpenTables (a method that provides a list of tables that have open checks); GetAllChecks (a method that provides a collection of all check matching a certain status), GetSplitTotals (a method to send a list of items to the agent and get back totals for that list), GetTableChecks (a method to collect all checks for a given table number); LockCheck (a method to lock a particular check in the POS system). UnlockCheck (a method to unlock a particular check in the POS), AddPayment (a method to add a card payment to the check and return a response containing payment authorization and receipt data); GetReceipt (a method to provide the receipt information for a particular check), and OrderItems (an order-entry method that places orders for the included list of items).

The particular strategy employed to implement a POS agent plug-in 314 for a specific POS system typically is dependent on the integration capabilities of the host POS system. Some POS systems provide APIs in the form of one or more of the following: dynamically-linked libraries (DLL), Microsoft .NET assemblies, Component Object Model (COM) DLLs, XML interfaces, web services, SOAP or other service-oriented architectures (SOA), SQL databases, and so on. Some implementations may employ several of these methods at once, for example, when retrieving check data from a SQL database, while submitting payment requests through an API or a XML request. The POS plug-in architecture illustrated in FIG. 3 allows the service provider to provide implementations for multiple POS systems, each hosted in an assembly containing system-specific functionality, while leaving the containing service and hosting framework unchanged. Once the data types, objects, and processes necessary to construct the objects that are expected by the IPOSPlugin and IAgent interfaces and the POS agent data contracts are exposed, a simple, yet robust, scalable and secure integration between the service provider system and the host POS system can then be implemented. This can be done in a variety of ways, and some example implementation strategies include the following. In a native implementation, which may be useful when the POS vendor (or service provider customer) does not wish to expose any details of the underlying system or data, the vendor or customer simply provides an implementation of the POS plug-in interface and its constituent objects in a compiled form (e.g., a .NET assembly DLL), conforming to the service provider's standards and naming conventions. In an API-based implementation, it is assumed that there is a POS-supplied API, although it is further assumed that the vendor does not wish to directly expose the underlying database and wishes to control functional access to the POS. In this case, the API should be callable (e.g., through .NET languages) and should expose enough data primitives, data types and functionality to fulfill the POS plug-in interface requirements. The service provider then provides the POS plug-in implementation and an abstraction/translation layer between the vendor API and the plug-in. In an XML-based implementation, there may be a vendor-provided API that comprises XML Requests and Replies over the web (using HTTP or SOAP transport), sockets or other file exchanges. In this approach, the service provider provides the POS plug-in implementation, serialization, and an abstraction/translation layer between the vendor API and the plug-in. In an SOA-based implementation, there is a vendor-provided API exposed through SOA (such as WCF, web services, SOAP, DCOM, CORBA or the like). In this approach, once again the service provider would provide the plug-in implementation. A hybrid implementation, in which there are various combinations of API, direct data access, and other technologies may be implemented by the vendor or customer, but the described plug-in approach may also be used in this scenario.

As illustrated in FIG. 3, the POS agent 305 preferably includes various functions to enable interoperability with the host POS functions. These functions include, without limitation and as described above, GetTableChecks( ), GetPOSSettings( ), GetPublicKey( ), AddPayment( ), GetFeatures( ), LockCheck( ), UnlockCheck( ), GetReceipt( ), GetTableStatus( ) and many others. Thus, for example, GetTableChecks( ) provides a collection of all checks for a given table number, LockCheck( ) function marks a particular check as in use, GetReceipt( ) provides receipt information for a particular check, GetTableStatus( ) provides information about whether a check is active on a particular table, and so on. The POS agent 305 includes diagnostic routines, such as GetAgentHealth( ). A POS agent state manager 315 manages the state of the tables being managed by the table-side units 320, and a query-table status 325 is used to determine the current state of a table (and, in particular, a check associated with that table).

Preferably, and as noted above, the middleware component serializes the requests it receives (asynchronously) from the table-side devices to enable prioritization of those requests and (if possible) concurrent processing by the POS system where appropriate for improved response-time to the table-side device. Some requests may be blocked or delayed, while others are not blocked, depending on the nature of the request and the context. For example, a request for a list of checks open on each table may be executed to the POS system in parallel, but those requests may be blocked while another table-side device is requesting to update check-level details to include a newly-ordered item.

With respect to check management, preferably the middleware component maintains a cache of menu item pricing to enable the ordering application on the table-side to reflect such pricing, preferably instantaneously. The table-side device itself maintains a local (to it) cached copy of the POS check for the table to provide a guest instantaneous access to the check detail when the guest launches the payment application on the device. To ensure consistency, preferably the middleware is operative to selectively or periodically query the POS system (perhaps in various stages of the payment flow or otherwise) to make sure that the local copy of the check is up-to-date and that the guest does not underpay or overpay. Preferably, this synchronization is crafted to minimize network traffic and wait time (latency) for the guest during payment processing. The middleware also preferably keeps track of adjustments to the check (e.g., discounts, comps, or the like) that are made available in the POS system and provides the ability (depending on configuration) to turn on or display them to the guest. The middleware also is operative to keep track of different tender types to be applied to each check by the guest or wait staff. As noted above, these tender types include, without limitation, credit card, gift cards, cash, coupons, house accounts, checks, and the like. The middleware also may be configured to limit how particular information associated with a tender type is exposed to the guest. The middleware may also manage and track use of multiple tender types in the event a single type is not enough to pay the check.

The middleware component operates as a service or executable on the POS system. Preferably, the middleware component is monitored, e.g., using monitoring tools, for any exceptions or faults. When such events occur, the middleware component may be restarted to ensure continuous operation. Event alerts or other notifications may be transmitted to a central monitoring system to generate logs for post-processing and debugging purposes.

Preferably, the POS agent is implemented in software, as a set of computer program instructions, executing in a single- or multi-processor hardware environment. Thus, the POS agent may be implemented as a non-transitory computer program product (an article) comprising computer-readable media having computer program instructions thereon.

The service provider table-side units and local device controller interoperate with the host POS system through the POS agent. Among other things, the interoperability enables the table-side unit to provide payment-related activities including retrieving the check, adding/deleting items, posting tender, and the like.

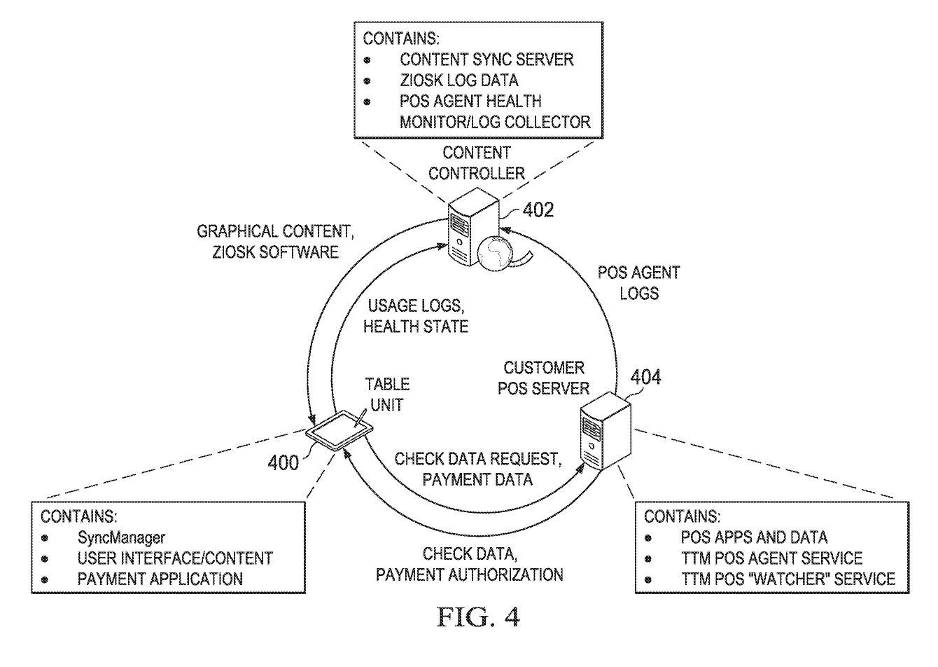

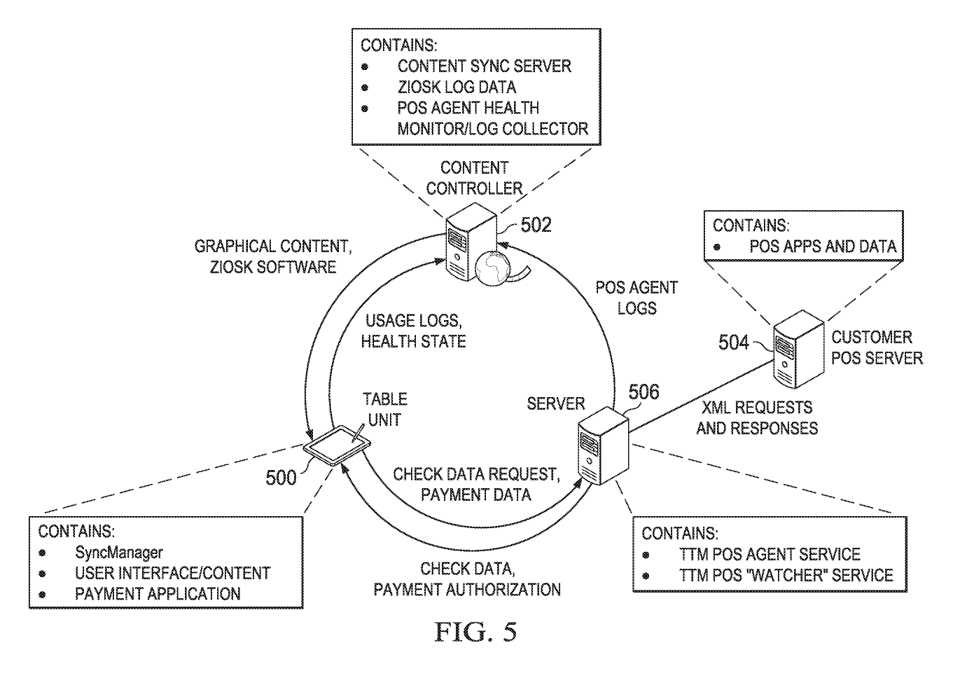

FIGS. 4 and 5 illustrate two representative POS integration embodiments illustrating how the same service provider units and the local device controller interoperate with disparate host POS systems. In a first embodiment, shown in FIG. 4, the table units 400 and local device controller 402 securely communicate directly with the customer POS server 404. The customer POS server 404 executes the POS agent described above (the POS agent service). A table unit 400 operates a synchronization manager, the user interface, and a payment application; the local device controller executes a content synchronization server, and a POS agent health monitor/log collector. The device controller 402 also maintains log data collected from the individual table units. In this approach, graphical and other content, as well as any unit operating system, is delivered from the local device controller 402 to the table units 400, and the table units 400 report back usage logs and health state data. The table units 400 communicate check data request and payment data to the customer POS server, which return check data and payment authorization. The customer POS server 404 also provides POS agent logs to the local device controller.

In the second embodiment, shown in FIG. 5, the tables units 500 and the local device controller 502 communicate as described above, but in this embodiment an additional server 506 (located within the POS operating environment) executes the POS agent and thus communicates with the table units. The server 506 communicates with the customer POS server 505 via XML-based requests and responses. This is the XML-based implementation described above.

The embodiments are merely representative, but they illustrate how the POS agent middleware enables the service provider system components to interoperate with disparate host POS system implementations.

The POS agent software component is highly advantageous as it provides a single interface for the individual table-side units and on the customer side provides a link to the customer's existing POS system. As noted above, in one embodiment this link is provided using the Windows Communication Foundation (WCF) through a POS agent interface. As described, the POS agent WCF interface allows the table-side unit to make requests to the host POS through the POS agent plug-in. Before the table unit device can make any requests to the POS system, however, it must first be authenticated. An authentication process that may be used for this purpose is now described.

Generally, the table-side unit requesting to be authenticated by the POS agent initiates the authentication process. The POS agent takes a public key sent with the request from the unit and creates an agent key, a challenge and a hash. The POS agent then stores, in an authentication table (a data structure), the following information: the generated agent key, the unit's MAC address, and the hash value. Preferably, the generated challenge value is encrypted using the unit's public key, and it is then returned to the unit along with a POS agent public key. Once the unit has received the encrypted challenge value and the POS agent public key, it calculates the hash from the received value, encrypts it using the POS agent public key, and then returns to the POS agent this calculated hash. If the value matches the value calculated by the POS agent, the unit is authenticated and ready for communication with the POS agent and POS system. In such event, the POS agent then sends the unit an agent payment public key, which public key allows the unit to send payment information to the POS agent software with the correct encryption key. Once the unit has been authenticated in this manner, it may begin requesting table and check information, POS settings, feature items, unavailable items, receipts, and also order items from the menu. The authentication table is purged at the restart of the agent software and periodically throughout operation.

To complete the requests (as received from the units), as noted above the POS agent must be allowed into the host POS system. As noted above, the POS agent plug-in enables the table unit(s) to connect with a particular type of POS system. In the described embodiment, the POS agent plug-in is a .NET class library that runs in support of the POS agent on the host POS system. This plug-in allows the table unit software and interface with the POS agent system to remain unchanged.

The following describes a concurrent traffic operation that is facilitated by the POS agent. As the POS agent receives requests from individual table units, the POS agent preferably has its associated WCF service hosting process create a new execution thread, and preferably each of these new threads is then executed concurrently. A request from a table unit preferably contains a unit identification number (UID), and a request identification number (RID) to enable the POS agent to verify that the unit making the request is authenticated. In particular, the POS agent uses the UID and RID to verify that the POS agent is not repeating a previous request that had not been completed. Each request made by a table unit preferably is stored in cache memory so that, in the event a particular unit fails to receive a response from the POS agent, the POS agent can re-send the response without completing the task an additional time. These identifiers are also useful to manage state if a particular table unit is used to make repeated similar orders. Thus, for example, during an order entry or check operation, preferably the POS agent checks for a repeated RID. If the RID is not repeated, a next operational verification the POS agent evaluates is check lock. If the check is not then locked, the POS agent locks the check until the request can be completed; this operation prevents any other unit from modifying the check or making multiple order entries with the same or additional requests.

The following describes a process for maintaining check information at the table unit, whether such information is consistent with check data held at the host POS system. To ensure that its local (table-side) check information is correct, preferably the table unit polls the POS agent and the host POS system for changes to existing table and checks, as well as for the creation of new checks. Preferably, the table unit caches the current check information to provide the patron(s) at the table virtually instance access to the check total. Periodically, the unit polls the POS agent for check total among other key items of the check and compares the returned information with the locally-cached data; if there are changes, the unit then requests details for the check. This request protocol ensures that the POS is not overloaded with detailed check calls until the check actually is changed. If a restaurant patron is seated at a table before a check can be opened, preferably the patron may still use the table side unit to order menu items. In such case, the unit caches the order until the POS agent and host POS system respond with the check ID. In this operation, preferably the unit continues to attempt to add items ordered to the check in the background.

The following describes a payment authorization and order/check change of corrections process that may be implemented using the POS agent. When a restaurant patron is ready to close his or her check, preferably the task is completed without having to wait on a member of the restaurant wait staff. In this operation, the patron uses the unit's magnetic strip card reader to submit a payment in the form of a credit, debit or gift card. If the patron desires to add a tip to the amount of the bill or to split the check, preferably those operations are completed as before the request to submit payment is sent to the POS agent. Preferably, before the patron submits a payment the unit conducts a final polling of the host POS for any final changes to the table check (before allowing the check to be closed). Once the POS agent and POS agent plug-in have completed the transaction with the host POS system, a payment response is returned to the unit along with a receipt that may be printed using the unit printer (if configured). Proper pricing of menu items is ensured by enabling the POS agent to poll the host POS system, which identifies prices changes, modifications, discounts and the like. Typically, those modifications override local pricing maintained at the table unit. If none are found, the POS agent uses a price (for a particular menu item) as stored in a standard price field. Typically, a price override or modification can only be conducted on the POS system; thus, when the POS agent detects an override, the POS agent pulls the change from the stored check information and sends the change to the unit, where the change data is then cached and reflected on the check total displayed by the unit.

The following describes several payment methods that are facilitated by the POS agent. Preferably, the unit provides the patron with several different methods for closing their check. An onboard magnetic card strip reader allows the patron to swipe gift cards, credit cards and debit cards. Once the card authorization has cleared the POS agent software and a POS card authorization service, a signature can be completed on the unit's display screen, or a hard copy may be printed out and signed. The onboard printer may be used for printing receipts, game results, and game and survey coupons. Another method of payment that may be used is a Near Field Communication (NFC) module. This module is used with Radio Frequency Identification (RFID)-enabled gift, credit and debit cards. Once the RFID card is placed near the NFC module, the card information is passed between the unit and the card RFID computer chip.

The following provides additional details regarding a preferred protocol used by the POS agent to authenticate table-side units to need to present to the POS system cardholder data (e.g., a credit card number, CSV, and the like). This approach to authenticating the table unit ensures that rogue devices or hackers cannot send data to the POS agent and to otherwise meet PCI PA-DSS requirements that the payment application have knowledge of the entities with which it is communicating for payment. As noted, the basic protocol is implemented by the POS agent and the table unit to ensure that only authenticated units are calling the POS agent services.

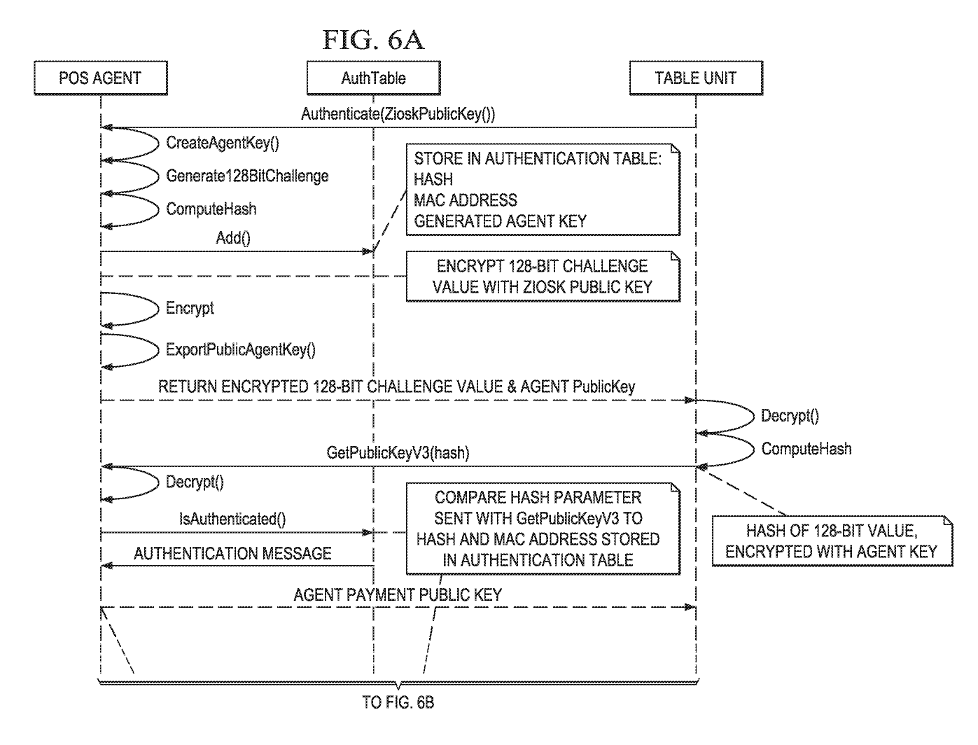

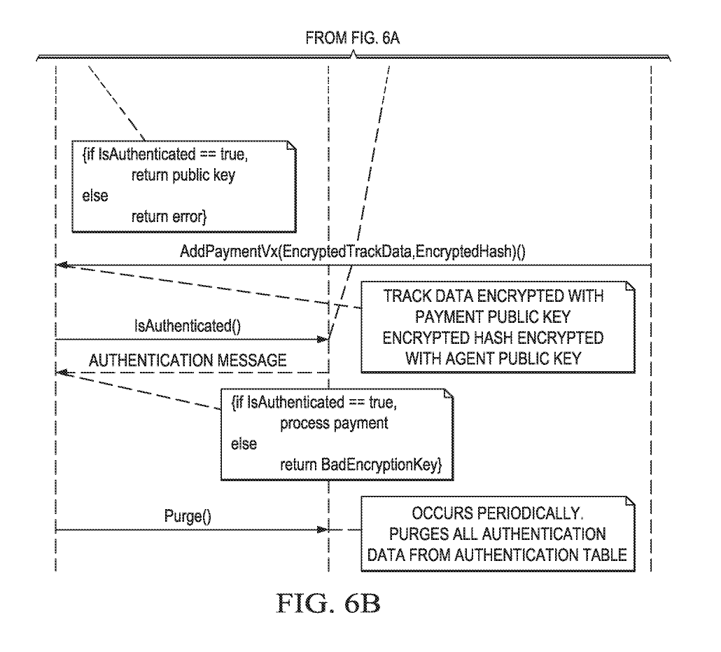

FIG. 6 is a UML diagram illustrating a preferred technique for authenticating the table-side unit to the POS agent according to this disclosure. In this diagram, the POS agent is shown in the left portion of the figure. Its associated authentication table (TableAuth) is shown in the middle portion, and the table unit being authenticated is shown on the right portion. Preferably, the protocol is implemented in both REST-based and SOAP-based WCF on the POS agent. Preferably, authentication tokens generated during the sequence are not stored persistently. The unit retains the authentication token while it is powered on so that, if the payment application is re-started, it uses the current in-memory authentication token.

The authentication protocol, as illustrated, preferably works as follows. An initial challenge response interaction is based on the Diffie-Hellman protocol, using ephemeral asymmetric key pairs (e.g., RSA keys). Preferably, the unit's call to the POS agent to authenticate contains a public key parameter. This may be a service provider-supplied RSA public key that is generated at the time of authentication. The POS agent uses this key to encrypt responses back to the unit. The POS agent creates an RSA key pair, generates and encrypts the preferably 128-bit challenge with the unit's public key, and exports to the unit its RSA public key. The 128-bit challenge and agent RSA public key are then returned to the unit. The unit stores (in non-persistent data storage) the challenge hash, generated agent RSA public key, and the caller MAC address. The unit decrypts the challenge with its private key and computes the hash. The unit then returns the hash encrypted by the POS agent public key; this hash may be returned in a call to GetPublicKey( ), which then returns the agent RSA public payment key used by the unit to encrypt payment card data. The preferred payment interactions are then as shown. As illustrated, the method Authenticate( ) is used to initiate the authentication protocol. The GetPublicKeyV3( ) method adds the authentication token (encrypted hash) as a parameter that is provided by the table unit to the POS agent. The AddPayment( ) method adds the authentication token as a parameter that is provided by the unit in a payment request.

The typical uses as illustrated are as follows. The nominal flow is that the table unit requests to be authenticated; the POS agent and the unit negotiate the appropriate keys and the unit is authenticated. The unit then uses a supplied authentication token when making payment requests.

Another use case occurs when the POS agent is re-started and loses in-memory authentication tokens. The unit then attempts to make payment. In such case, the POS agent rejects the request because the authentication token passed with the request is unknown. The table unit then re-initiates the authentication sequence described above in the nominal flow. The unit is then authenticated, all without impacting the patron.

Another use case occurs when the table unit is re-started and loses authentication data. In this case, the table unit initiates the authentication sequence described above in the nominal flow, and the POS agent replaces any previous authentication for the unit with new data obtained during the re-authentication.

While the above describes a particular order of operations performed by certain embodiments of the disclosed subject matter, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

While given components of the system have been described separately, one of ordinary skill will appreciate that some of the functions may be combined or shared in given instructions, program sequences, code portions, and the like. While the disclosed subject matter has been described in the context of a method or process, the subject disclosure also relates to apparatus for performing the operations herein. This apparatus may be specially constructed for the required purposes, or it may comprise a general-purpose computing entity selectively activated or reconfigured by a stored computer program stored. Such a computer program may be stored in a computer readable storage medium, such as, but is not limited to, any type of disk including an optical disk, a CD-ROM, and a magnetic-optical disk, flash memory, a read-only memory (ROM), a random access memory (RAM), a magnetic or optical card, or any type of non-transitory media suitable for storing electronic instructions.

While given components of the system have been described separately, one of ordinary skill will appreciate that some of the functions may be combined or shared in given instructions, program sequences, code portions, and the like.

Having described our invention, what is claimed is as follows.

1. A point-of-sale (POS) system configured to interface a plurality of customer terminals to a plurality of disparate point-of-sale (POS) sub-systems, the POS system comprising:
a host point-of-sale (POS) system comprising a plurality of application programming interfaces, the plurality of application programming interfaces including a first application programming interface (API) that interfaces to a point-of-sale (POS) database;
a point of sale (POS) agent comprising a POS agent communication interface layer that includes an intelligent queuing mechanism configured to buffer incoming asynchronous requests received from the plurality of customer terminals; and
a Microsoft .NET library layer configured to communicate with the plurality of application programming interfaces of the host POS system,
wherein the POS agent is disposed between the Microsoft .NET library layer and the host POS system and provides a layer of abstraction that enables the host POS system to interoperate with the plurality of disparate (POS) sub-systems.
